(19) United States
(12) Patent Application Publication
(10) Pub. No.: US 2015/0331257 A1
(43) Pub. Date: Nov. 19, 2015

(54) METHOD OF FORMING VARIABLE FOCUS EYEWEAR

(71) Applicant: Dow Corning Corporation, Midland, MI (US)

(72) Inventors: David Nicholas CROSBY, Oxford (GB); Richard Edward TAYLOR, Oxford (GB); Gregor Allan STOREY, Oxfordshire (GB)

(21) Appl. No.: 14/808,376

(22) Filed: Jul. 24, 2015

Related U.S. Application Data
(62) Division of application No. 14/281,083, filed on May 19, 2014.
Application No. 14/281,083 is a continuation of application No. PCT/US2013/032183, filed on Mar. 15, 2013.
(60) Provisional application No. 61/624,867, filed on Apr. 16, 2012.

(51) Int. Cl. G02C 7/08; G02C 7/02; B29D 12/02; G02C 13/00

(52) U.S. Cl. CPC G02C 7/085; G02C 13/001; G02C 7/027; B29D 12/02

(57) ABSTRACT

A method of forming a support member to a flexible membrane is provided by the present disclosure. In one form, the method includes placing the flexible membrane onto an outer periphery of a fixed tool, translating a movable tool towards the fixed tool, and engaging the flexible membrane such that the flexible membrane is deformed and placed into tension. A molten resin is then injected into a support ring molding cavity, and the resin is allowed to cool such that the support ring is secured to the tensioned flexible membrane. The movable tool is then translated away from the fixed tool to eject a flexible membrane and support ring assembly.

### CROSS REFERENCE TO RELATED APPLICATIONS

This application is a divisional of U.S. application Ser. No. 14/281,083, filed on May 19, 2014, which is a continuation of PCT Application Serial No. PCT/US2013/032183 filed Mar. 15, 2013, which claims the benefit of U.S. Provisional Application No. 61/624,867 filed Apr. 16, 2012, the entire contents of which are incorporated herein by reference in their entireties.

### FIELD

The present disclosure relates generally to variable focus lenses. More specifically, the disclosure relates to methods of forming variable focus lenses for use in fluid-filled adjustable eyeglasses.

### BACKGROUND

The statements in this section merely provide background information related to the present disclosure and may not constitute prior art.

Fluid-filled adjustable eyeglasses are known in the art and generally include lenses that are varied in optical power by adjusting pressure of the fluid within the lenses, in order to suit the unique vision correction needs of individual users/wearers. These fluid-filled adjustable eyeglasses are advantageous in many ways. For example, one model of the eyeglasses can suit the needs of a large number of wearers, which simplifies logistical and storage challenges in remote or underdeveloped regions. In these regions, efficient distribution is enabled with fluid-filled adjustable eyeglasses without the need for a complex and expensive infrastructure required for conventional eyeglasses.

Additionally, corrective eyeglasses can be provided in one sitting, without the wait and return trip for a prescription set of conventional eyeglasses. Moreover, fluid-filled eyeglasses can be provided by laypersons with minimal training, simply by providing a testing and dispensing protocol, thus eliminating the need for a certified optometrist in many cases. This scenario has substantial benefits in remote or underdeveloped regions where access to professional care and funding is severely limited.

Adolescents and young adults are often overlooked when it comes to the design and distribution of corrective eyeglasses, and the majority of fluid-filled eyeglasses are typically designed for the average adult. As a result, providers of fluid-filled eyeglasses may not be able to provide adolescents and young adults with appropriate eyewear because successful fitting and adjustment of known fluid-filled eyeglasses is not possible, and thus their vision needs remain a challenge.

### SUMMARY

In one form of the present disclosure, a method of forming a support member to a flexible membrane is provided that comprises placing the flexible membrane onto an outer periphery of a fixed tool, the fixed tool defining a central recess. A movable tool is translated towards the fixed tool and engages the flexible membrane proximate the outer periphery of the fixed tool with at least one spring-loaded member. The movable tool defines a central protrusion and a support ring molding cavity disposed within the central protrusion. The movable tool is translated further towards the fixed tool and engages the flexible membrane with the central protrusion such that the flexible membrane is deformed into the central recess of the fixed tool and placed into tension. A molten resin is then injected into the support ring molding cavity, and is allowed to cool such that the support ring is secured to the tensioned flexible membrane. Then, the movable tool is translated away from the fixed tool to eject a flexible membrane and support ring assembly.

In another form, a method of forming a support member to a flexible membrane is provided that comprises molding a support ring within a tool in which a flexible membrane is tensioned, the support ring being molded against the flexible membrane while the flexible membrane is in tension.

In still another form, a method of securing a support member to a flexible membrane is provided that comprises placing the flexible membrane onto a tool and pretensioning the flexible membrane, injecting a molten resin into a support ring molding cavity that is exposed to a portion of the pretensioned flexible membrane, and allowing the resin to cool such that the support ring is secured to the tensioned flexible membrane.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a set of adjustable eyeglasses constructed in accordance with the teachings of the present disclosure;

FIG. 2 is a partial exploded perspective view of the set of adjustable eyeglasses in accordance with the teachings of the present disclosure;

FIG. 3 is a side cross-sectional view of a lens assembly constructed in accordance with the teachings of the present disclosure;

FIG. 3a is an enlarged view of an interface between a support member and a flexible membrane constructed in accordance with the teachings of the present disclosure;

FIG. 4a is a side view of a tooling arrangement and a step in forming a support member to a flexible membrane in accordance with a method of the present disclosure;

FIG. 4b is a side view of the tooling arrangement and a further step in forming a support member to a flexible membrane in accordance with one method of the present disclosure;

FIG. 4c is a side view of the tooling arrangement and another step in forming a support member to a flexible membrane in accordance with one method of the present disclosure; and

FIG. 4d is a side view of the tooling arrangement and yet another step in forming a support member to a flexible membrane in accordance with a method of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

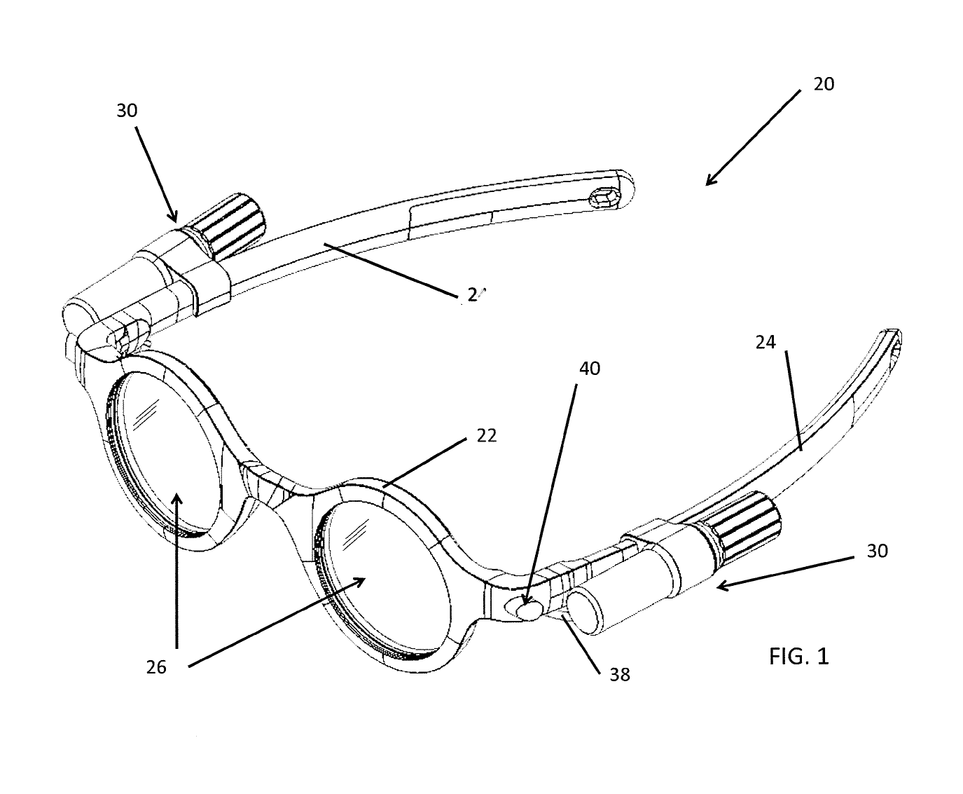

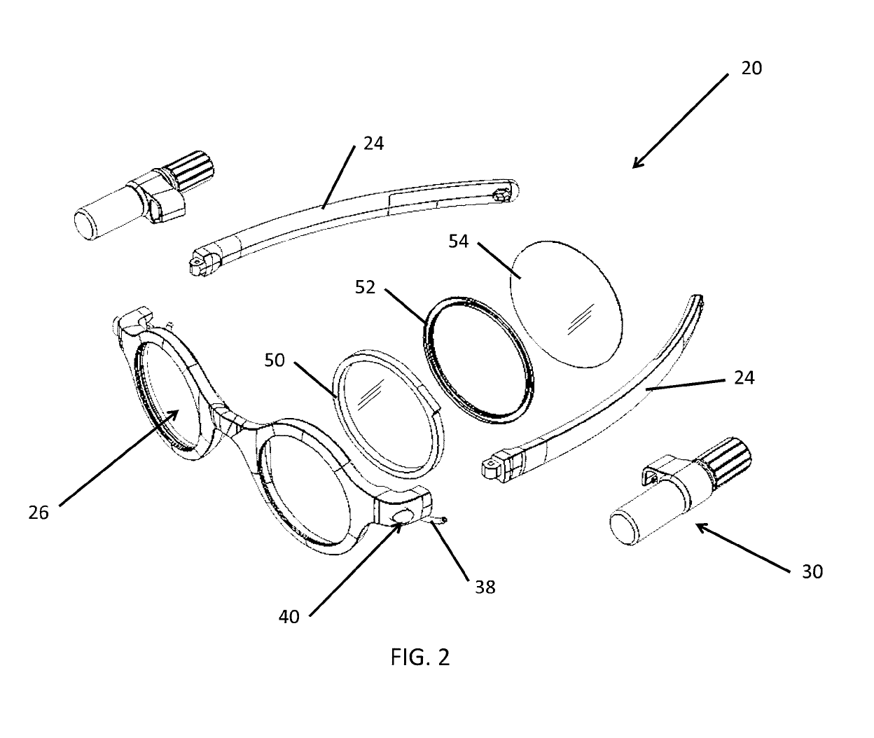

Referring to FIGS. 1 and 2, a set of adjustable eyeglasses according to the present disclosure is illustrated and generally indicated by reference numeral 20. As shown, the adjustable eyeglasses 20 comprise a frame member 22, two side arms 24 secured to the frame member 22, and two fluid-filled variable lenses 26 disposed within the frame member 22.

Two adjuster mechanisms 30 are removably secured to a portion of the adjustable eyeglasses 20, and a connecting tube 38 that functions as a conduit for the flow of a silicone fluid extends from the adjuster mechanism 30, through the frame member 22, and into the fluid-filled variable lenses 26. Two sealing devices 40 are disposed at opposed ends of the frame member 22, which are activated once the proper optical power is set with the adjuster mechanisms 30. Operation and construction of these elements are described in greater detail in co-pending application titled “Sealing System for Use in Variable Focus Lenses,” which is a continuation of PCT Application Serial No. PCT/US2013/032192, filed concurrently herewith, and is commonly assigned with the present application, the contents of which are incorporated by reference herein in their entirety.

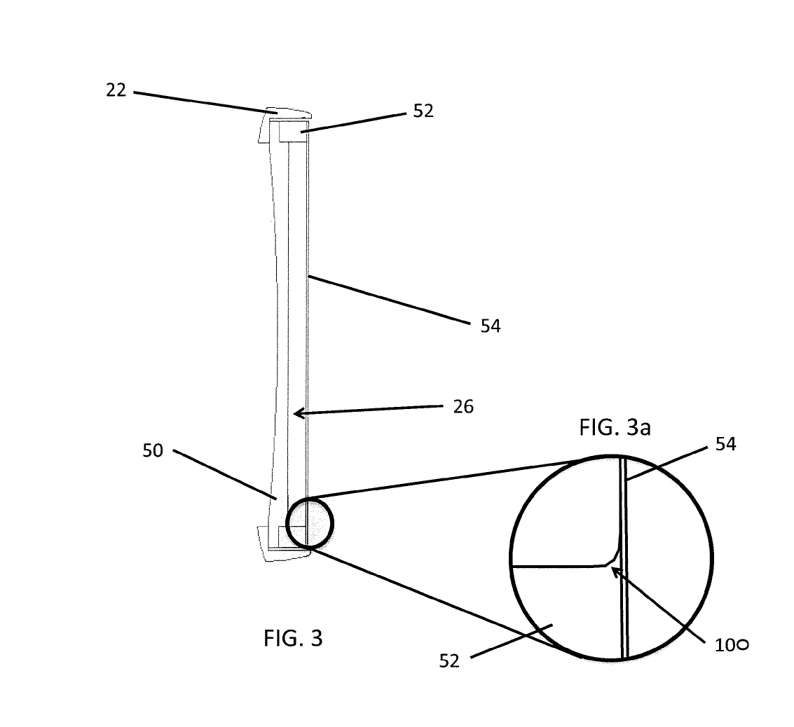

As shown in FIGS. 2 and 3, each of the fluid-filled variable lenses 26 generally include a rigid lens 50, a support member (or ring) 52, and a flexible membrane 54. Advantageously, the flexible membrane 54 is pretensioned and directly bonded to the support member 52 as set forth in greater detail below. As such, a more efficient manufacturing process is provided that eliminates conventional joining steps, such as adhesive bonding, laser welding, or ultrasonic welding, among others. Additionally, in a pretensioned state, waviness of the flexible membrane 54 is reduced, thus eliminating unacceptable optical aberrations.

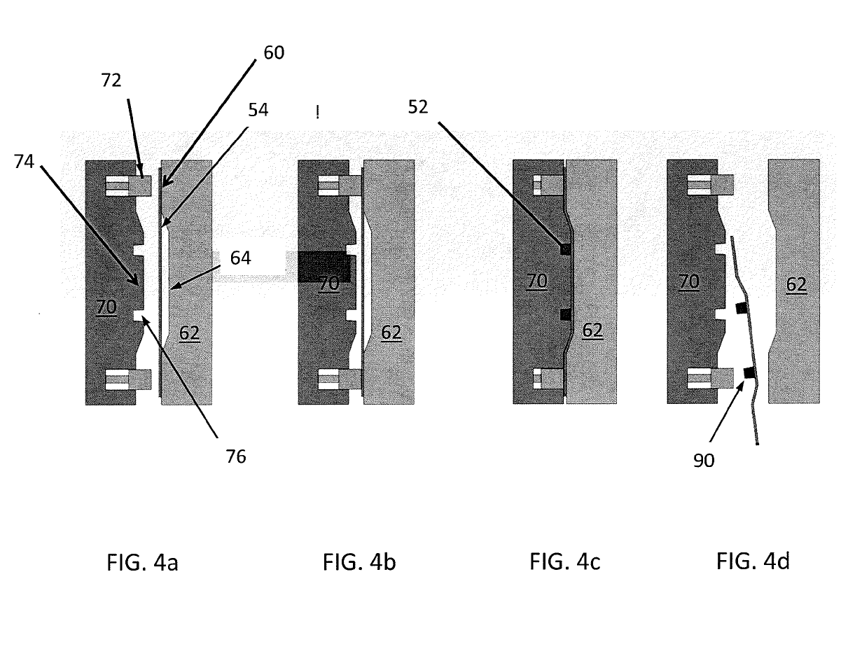

Referring now to FIGS. 4a-4d, a method of forming the support member 52 to the flexible membrane 54 is illustrated and now described in greater detail. First, the flexible membrane 54 is placed onto an outer periphery 60 of a fixed tool 62, the fixed tool 62 defining a central recess 64 as shown. In one form, the flexible membrane 54 is held against the outer periphery 60 with static electricity, although it should be understood that alternate approaches such as external mechanical devices may be employed while remaining within the scope of the present disclosure.

Next, a movable tool 70 is translated towards the fixed tool 62 to engage the flexible membrane 54 proximate the outer periphery 60 of the fixed tool 62 with at least one spring-loaded member 72. In one form, this spring-loaded member 72 is a continuous annulus member, however, it should be understood that other engagement techniques, as set forth in greater detail below, may be employed while remaining within the scope of the present disclosure. As further shown, the movable tool 70 defines a central protrusion 74 and a support ring molding cavity 76 disposed within the central protrusion 74.

The movable tool 70 is translated towards the fixed tool 62 and engages the flexible membrane 54 with its central protrusion 74. As movable tool 70 continues to translate, the central protrusion 74 progressively contacts the flexible membrane 54, and the flexible membrane 54 is deformed into the central recess 64 of the fixed tool 62 and placed into tension. Next, while the flexible membrane 54 is held in tension, a molten resin is injected into the support ring molding cavity 76, and then the resin is allowed to cool such that the support ring 52 is secured to the tensioned flexible membrane 54. More specifically, the pretensioned flexible membrane 54 is directly bonded to the support ring 52, without the need for an adhesive or additional joining step. As used herein, the term “directly bonded” shall be construed to mean physically and more specifically molecularly joined through the application of heat and pressure in a molding process such as that set forth herein, without the need for any adhesive material or subsequent joining process such as laser or ultrasonic welding. In one form of the present disclosure, a thin thermoplastic coating is provided around the flexible membrane 54 proximate the support ring 52 in order to promote the reptation or reticulation of polymer bonds between the flexible membrane 54 and the support ring 52.

Finally, to complete the forming process, the movable tool 70 is translated away from the fixed tool 62 once the resin has cooled, and a flexible membrane and support ring assembly 90 is ejected from the tools 62 and 70. After the flexible membrane and support ring assembly 90 is ejected, any excess material outside the support ring 52 is removed or trimmed by a laser cutter or a mechanical blade.

Once trimmed, the flexible membrane and support ring assembly 90 is joined to the rigid lens 50 using a laser welding process. It should be understood that other joining methods may be employed, such as ultrasonic welding, adhesive bonding, mechanical attachment, or magnetic attachment, among others, while remaining within the scope of the present disclosure.

In one form, the flexible membrane 54 is a biaxially-oriented polyethyl terephthalate (PET) material having a thickness of at least about 100 microns. More specifically, the thickness is between about 150 and about 180 microns. This thickness is much thicker than known flexible membranes, which allows the flexible membrane 54 of the present disclosure to be more robust and thus eliminates the need for a protective cover, as with other fluid-filled flexible lenses in the art. Additionally, the adjustable eyeglasses 20 have improved optical and operational performance without having a protective cover. Optically, the improved clarity leads to higher contrast as there are fewer surface reflections due to the elimination of active optical surfaces. Operationally, the elimination of a protective cover reduces the weight of the lens and thus improves aesthetics.

The flexible membrane 54 may also be provided with certain coatings to improve its performance. For example, one or more of a hard-coating, an anti-reflective coating, and a hydrophobic coating may be applied to the flexible membrane 54. The hard-coating improves durability, the anti-reflective coating reduces surface reflections, and the hydrophobic coating reduces adhesion of dirt or other contaminants. In one form, a hard-coating is applied over the flexible membrane 54, and then an anti-reflective coating is applied over the hard-coating. Accordingly, it should be understood that one or any combination of coatings may be employed while remaining within the scope of the present disclosure.

The support ring 52 is generally a thermoset or thermoplastic polymer material, and in one form is a transparent material such as an optical polyester. In one form, referring back to FIG. 3a, the support ring 52 defines a radiused transition 100 adjacent the flexible membrane 54 in order to reduce stresses at the boundary between the support ring 52 and the flexible membrane 54, thus improving mechanical robustness. The support ring 52, in one method, is formed by an injection molding process.

The rigid lens 50 in one form is an optical polymer material, such as by way of example, polymethyl methacrylate (PMMA), polycarbonate, or optical polyesters. Additionally, an optical resin such allyl diglycol carbonate (ADC) may be employed.

It should be understood that the specific tooling arrangement as described an illustrated herein is not intended to limit the scope of the present disclosure. Generally, the claimed invention is a method of forming a support member to a flexible membrane comprising molding a support ring within a tool in which a flexible membrane is tensioned, the support ring being molded against the flexible membrane while the flexible membrane is in tension. In one alternate form, the tool comprises at least two pieces and at least one of the two pieces is translated against the other to tension the flexible membrane prior to the support ring being molded. In another form, an independent core is disposed within one of the two tool pieces, the independent core being translatable to form the flexible membrane and to tension the membrane. In still another form, the flexible membrane is tensioned by a device external to the tool. It should be understood that these and other methods of forming a support member to a flexible membrane by molding a support ring within a tool in which a flexible membrane is tensioned should be construed as falling within the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of forming a support member to a flexible membrane comprising:
placing the flexible membrane onto an outer periphery of a fixed tool, the fixed tool defining a central recess;
translating a movable tool towards the fixed tool and engaging the flexible membrane proximate the outer periphery of the fixed tool with at least one spring-loaded member, the movable tool defining a central protrusion and a support ring molding cavity disposed within the central protrusion;
continuing to translate the movable tool towards the fixed tool and engaging the flexible membrane with the central protrusion of the movable tool such that the flexible membrane is deformed into the central recess of the fixed tool and placed into tension;
injecting a molten resin into the support ring molding cavity;
allowing the resin to cool such that the support ring is secured to the tensioned flexible membrane; and
translating the movable tool away from the fixed tool to eject a flexible membrane and support ring assembly.

2. The method according to claim 1, wherein the flexible membrane is held against the outer periphery of the fixed tool with static electricity.

3. The method according to claim 1, wherein at least a portion of the flexible membrane proximate the support ring is first coated with a thermoplastic material prior to forming the assembly.

4. The method according to claim 1 further comprising trimming excess material from the flexible membrane with a laser cutter.

5. A set of adjustable eyeglasses fabricated according to the method of claim 1.

6. The set of adjustable eyeglasses according to claim 5, wherein the flexible membrane is a biaxially-oriented polyethyl terephthalate (PET) material having a thickness of at least about 100 microns.

7. The set of adjustable eyeglasses according to claim 5 further comprising at least one coating applied to the flexible membrane selected from the group consisting of a hard-coating, an anti-reflective coating, and a hydrophobic coating.

8. The set of adjustable eyeglasses according to claim 5, wherein the support ring comprises a transparent material.

9. The set of adjustable eyeglasses according to claim 5, wherein the support ring comprises radiused edges adjacent the flexible membrane.

10. A method of forming a support member to a flexible membrane comprising molding a support ring within a tool in which a flexible membrane is tensioned, the support ring being molded against the flexible membrane while the flexible membrane is in tension.

11. The method according to claim 10, wherein the support ring is injection molded.

12. The method according to claim 10, wherein the tool comprises at least two pieces and at least one of the two pieces is translated against the other to form the flexible membrane prior to the support ring being molded.

13. The method according to claim 12 further comprising an independent core disposed within one of the two tool pieces, the independent core being translatable to form the flexible membrane and to tension the membrane.

14. The method according to claim 10, wherein the flexible membrane is tensioned by a device external to the tool.

15. A set of adjustable eyeglasses fabricated according to the method of claim 10.

16. A method of securing a support member to a flexible membrane comprising:
placing the flexible membrane onto a tool and pretensioning the flexible membrane;
injecting a molten resin into a support ring molding cavity that is exposed to a portion of the pretensioned flexible membrane; and
allowing the resin to cool such that the support ring is secured to the tensioned flexible membrane.

17. The method according to claim 16, wherein the flexible membrane is pretensioned by deforming with a movable tool.

18. A set of adjustable eyeglasses fabricated according to the method of claim 16.

19. The method according to claim 16, wherein the pretensioned flexible membrane is molecularly joined to the support ring through the application of heat and pressure.

20. The method according to claim 16, wherein the pretensioned flexible membrane is molecularly joined to the support ring without a subsequent joining process.
